(19) United States
(12) Patent Application Publication
(10) Pub. No.: US 2026/0218569 A1
(43) Pub. Date: Jul. 30, 2026

(54) TELESCOPIC LADDER

(71) Applicant: GUANGDONG WRIGHT HOUSEWARES CO.,LTD., Foshan (CN)

(72) Inventor: Yi YANG, Foshan (CN)

(21) Appl. No.: 19/068,031

(22) Filed: Mar. 3, 2025

(30) Foreign Application Priority Data
Jan. 24, 2025 (CN) 202510121800.7

(51) Int. Cl. E06C 1/12; E06C 7/08

(52) U.S. Cl. CPC E06C 1/125; E06C 7/081; E06C 7/083

(57) ABSTRACT

The present invention relates to a telescopic ladder comprising a telescopic ladder section and a ladder foot section, wherein the telescopic ladder section comprises a rail that is configured to have a fit between at least two rungs, each rung of rail includes a rung, a bracket, and a rail tube, and the rail tube comprises a first arc edge plate, a straight edge plate, and a second arc edge plate. Compared with traditional circular tubes, this structure significantly improves the anti-torsion ability of rail tubes, and ensures the stability and safety of the ladder, and performs excellently especially under high load operating conditions.

### CROSS-REFERENCE TO RELATED APPLICATIONS

This application claims priority to Chinese Patent Application No. 202510121800.7, filed on Jan. 24, 2025, which is hereby incorporated by reference in its entirety.

### TECHNICAL FIELD

The present invention relates to a telescopic ladder.

### BACKGROUND

Telescopic ladder, a common tool product widely used in households, engineering, and other fields, is an ideal choice for high-altitude operations, maintenance, cleaning, and other work because of its portability and adjustable length. However, the telescopic elevators currently sold in the market still face some technical limitations, which affect their performance, safety, and user experience.

The frames of existing telescopic ladders are usually based on a circular tube design. Although this design simplifies the production process to some extent, the weak torsional resistance of circular tubes makes the ladder prone to deformation or shaking during use, affecting its stability and safety.

The different rungs of existing telescopic ladders have the same size and most of them are based on flat design. This structure not only provides poor stepping comfort, but also limits the load-bearing capacity of the rungs, and may pose safety hazards especially in high-intensity operations.

Traditional telescopic ladders are usually based on step-by-step folding, and some products support one click folding. However, one click folding is so fast that and accidental injuries such as hand pinching may be caused due to the rapid contraction of rail tube during operation, resulting in insufficient safety.

### SUMMARY

The purpose of the present invention is to provide a telescopic ladder that enhances the anti torsion ability of the rail and improves users'stepping comfort.

The purpose of the present invention is achieved as follows:

A telescopic ladder comprising a telescopic ladder section and a ladder foot section, wherein the telescopic ladder section comprises a rail that is configured to have a fit between at least two rungs:

each rung of rail includes a rung, a bracket, and a rail tube, wherein the bracket has a plug-in channel that runs through the top and bottom, a connector is provided on the side of the bracket, the inner wall of the plug-in channel is spaced with at least four fitting bumps, and a upper port of the plug-in channel is provided with an inward flanging that extends towards the center direction of the plug-in channel;

the upper end of each rail tube is inserted into the corresponding bracket's plug-in channel through the lower port of plug-in channel and pressed against the inward flanging to connect the rail tube and the bracket, the fitting bumps reduce the fitting gap between the rail tube and the plug-in channel of bracket, and a descent control device is provided at a lower port of each rail tube;

the rungs are disposed between the rail tubes, and the ends of the rungs are connected to the corresponding connector, respectively;

a rail tube of an upper rung of rail is disposed inside a rail tube of a lower rung of the rail, and a folding mechanism is provided between the upper rung of rail and lower rung of rail to lock or unlock the unfolded state between the upper rung of rail and the lower rung of rail;

the ladder foot section comprises a rung, a bracket, and a ladder foot tube, wherein the bracket is provided at the ladder foot tube, the rung is disposed between the rail tubes, and the ends of the rung are connected to the corresponding connectors, respectively;

the rail tube of the last rail is sleeved inside the ladder foot tube of the ladder foot section;

the rail tube of the upper rung of rail has a smaller size than the rail tube of the lower rung of rail, and the rail tube of the last rail has a smaller size than the ladder foot tube;

the rail tube comprises a first arc edge plate, a straight edge plate, and a second arc edge plate, wherein one end of the straight edge plate is connected to the first arc edge plate, and the other end of the straight edge plate is connected to the second arc edge plate, a first circular arc angle is formed at the connection between the straight edge plate and the first arc edge plate, and a second circular arc angle is formed at the connection between the straight edge plate and the second arc edge plate, thereby enclosing a rail tube having a “bread” shaped cross section;

an inner wall of an opening of the bracket is spaced with at least four fitting bumps that are configured to enclose a limit port, the upper rung of rail tube passing through the limit port of the bracket is sleeved inside the rail tube of the lower rung of rail, and the limit port is configured to reduce a fitting gap between the upper rung of rail tube and the bracket;

the rung has a curved surface that is easy to step on, and the size of the rung of the telescopic ladder is configured to increase with the size of the rail tube.

The ladder rail is design with a “bread” shaped cross section, and forms a stable structure through the combination of the first arc edge plate, straight edge plate, and second arc edge plate. Compared with traditional circular tubes, this structure significantly improves the anti-torsion ability of rail tubes, and ensures the stability and safety of the ladder, especially performing better under high load operating conditions.

The lower port of each rail tube is provided with a descent control device to avoid the risk of hand clamping caused by excessive speed during the traditional one-click closing process by effectively controlling the contraction speed of ladder rail. At the same time, at least four fitting bumps are added to the inner wall of the plug-in channel of the bracket, reducing the fitting clearance between the rail tube and the plug-in channel of bracket, further improving the safety. Moreover, this optimized design effectively improves the anti-torsion ability and assembly quality of ladder rail, extending products'service life.

The arc-shaped surface of the rung increases the contact comfort of feet and reduces fatigue during long-term use. Meanwhile, the size of rungs increases step by step with the increasing size of ladder rail. Rungs of different sizes are configured for different ladder rails to improve the load-bearing capacity and ensure safety at different working heights.

Based on the optimized structural design, the telescopic ladder is not only suitable for general housework, but also meets the high-intensity work requirements in professional engineering applications. The improved anti-torsion ability, load-bearing capacity, and safety performance enables the ladder to adapt to more complex scenarios with enhanced applicability.

The purpose of the present invention can also be addressed by the following technical measures:

In further, the rung comprises a circular arc plate, a right angle plate, and a bevel edge plate, and one end of the circular arc plate is connected to the right angle plate, and the other end of the circular arc plate is connected to the bevel edge plate, thereby enclosing a rung having a “T” shaped cross section, the circular arc plate has a circular arc surface, and the circular arc surface is provided with a plurality of concave-convex anti-skid bars at intervals.

The rung is designed with “T-shaped” cross section, and the circular arc surface of the circular arc plate conforms to the sole structure and provides a more comfortable stepping experience. The concave-convex anti-skid bars effectively increase the anti-skid performance of rung surface, reducing the risk of slipping when used in wet and slippery environments.

Different rail tubes are provided with corresponding sized rungs, and the width of rungs increases step by step with the size of rail tubes, enhancing the load-bearing capacity of rungs. This design is more in line with the demand for load-bearing performance when the ladder has an increasing height, making ladder climbing-up and-down safer and more stable, suitable for various work scenarios.

The circular arc tread surface not only conforms to the sole structure, but also reduces the pressure on the foot during long-term operation, significantly improving users'comfort. This design is particularly suitable for working at height that require prolonged standing or climbing.

The arrangement of concave-convex anti-skid bars at intervals on the circular arc plate effectively improves users'operation safety in various complex environments, and significantly reduces the risk of slipping, especially in rainy or oily fields. In addition, the combination structure of circular arc surface, right angle plate and oblique edge plate provides a more stable support, further enhancing the overall safety.

The designed rungs of different widths and sizes can not only meet the needs of household applications, but also satisfy the higher requirements of professional scenarios such as engineering construction. As the size of ladder rail increases, the width of rungs synchronously increases, providing stable support for users when operating at different heights, significantly improving the versatility of the ladder.

In further, the descent control device comprises a bottom cover, and the bottom cover is disposed at a lower port of the rail tube and has an air hole.

A bottom cover with air holes is provided at the lower end of the rail tube, so that the slow descent device can effectively regulate the air circulation speed, slow down the speed of rail tube during contraction and avoid problems such as hand pinching or impact caused by rapid contraction. This design significantly improves the safety of ladder use, especially suitable for scenarios where frequent folding is required.

The bottom cover protects the rail tube, avoiding edge wear or deformation caused by frequent use. At the same time, the air hole designed reduces the impact of air resistance on the rail tube, further protecting the fitting part between the rail tube and the bracket, and extending the service life of the overall device.

The addition of a descent control device realizes a smoother and more controllable folding process of rail tube, and users do not need to worry too much about discomfort or danger caused by too fast folding speed. This smooth contraction experience enhances users'confidence and satisfaction with the product, making it suitable for both home and professional applications.

The designed air holes on the bottom cover are adjustable to some extent. The size or quantity of air holes can be adjusted flexibly to adapt to the rail tubes of different models and sizes, thereby increasing the universality and applicability of the product.

During the process of folding rail tube, the descent control device slows down the air flow velocity through the designed air holes, avoiding the impact noise that may occur during rapid contraction. This improvement not only enhances the comfort of usage process, but also provides users with a quieter working environment.

In further, a upper port of the plug-in channel is provided with an inward flanging that extends towards the center direction of the plug-in channel, the rail tube is provided with a blocking block, the rail tube of the upper rung of rail is configured to slide along an inner cavity of the rail tube of the next rung of rail until the blocking block is pressed against the inward flanging, and the upper rung of rail tube and the lower rung of rail tube are in a fully unfolded state.

The inward flanging on the inner wall of plug-in channel of the bracket is used in conjunction with the blocking block on the rail tube, effectively limiting the sliding range of the upper rung of rail tube. When the blocking block is pressed against the inward flanging, the rail tubes at all levels of the ladder are fully extended, and this design enhances the stability of the ladder after deployment, preventing the rail tubes from detaching.

Based on the coordinated design of inward flanging and blocking block, the rail tube can achieve automatic limit without additional operation when unfolded, simplifying the user's operation steps and improving the convenience of use. This design is particularly suitable for scenarios where quick expansion and fixation is required.

The combination of inward flanging and blocking block not only stabilizes the unfolded state of rail tube, but also effectively prevents the rail tube from accidental detachment due to external forces, and significantly improves the use safety of ladder, as well as reliability, especially working at height.

The designed inward flanging and blocking block with high universality can adapt to rail tubes of different sizes, and has a simple structure that is easy to produce and assemble modularly. This optimized design reduces production costs while enhancing the product's market adaptability.

The innovative design of the inward flanging and blocking block effectively solves the problem of traditional ladders being prone to slipping and instability during deployment, significantly improving the safety and usability of the ladder.

In further, the telescopic ladder further comprises a resilient and wear-resistant blocking plate, wherein the blocking plate is configured to be on a side wall of the rail tube and forms the blocking block.

The resilient and wear-resistant blocking plates on a side wall of rail tube form the blocking blocks, effectively preventing the rail tube from slipping out during the stretching process. When the blocking plates touch the inward flanging of the bracket of lower rail, the rail tube automatically stops stretching to provide reliable anti-detachment and greatly improve the safety performance of the ladder, especially in high-frequency applications.

The direct anti-detachment structure of traditional rail tubes is prone to wear and tear due to frequent use, which increases the cost of replacing components. The use of wear-resistant blocking plates as an anti-detachment structure not only extends the service life of rail tube, but also reduces the risk of wear, thereby reducing subsequent maintenance costs and improving the durability of the ladder.

The blocking plates can eliminate some gaps between the upper and lower rungs of rail tubes, reducing shaking or noise caused by looseness. This optimized gap design improves the overall stability of the ladder, making it smoother and safer to use.

The blocking plates play a stable guiding role when the rail tube is stretching, and avoids the deviation or jamming of rail tubes, so that the ladder can stretch smoothly and more efficiently.

Resilient blocking plates not only prevent detachment, but also adapt flexibly to stretching operations of different strengths. Because of strong wear resistance, it is not easily damaged by environmental changes such as temperature or humidity. This design ensures that the ladder can maintain stable performance in various complex usage environments.

The dual functional design of blocking plates not only provides protection, but also takes into account guidance and gap optimization functions, achieving multi-purpose use. This design enhances the functionality of the ladder, and also further optimizes the overall structure, reflecting the efficiency and innovation of the design.

In further, the center of the first arc edge plate and a center of the second arc edge plate are on a same straight line, and the first arc edge plate has a greater radius than the second arc edge plate, and the first arc angle has the same radius as the second arc angle.

The rail tube is designed with a bread shaped cross section, and the large arc of the first arc edge plate and the small arc of the second arc edge plate have the center on the same straight line, and the first arc angle has the same radius as the second arc angle. This structural design can effectively limit the relative rotation angle of the rail tube, significantly enhance the anti-torsion ability of the ladder, and make it more stable and reliable during use.

The bread shaped tubes designed with cross sections, by combining two straight edges, different sized circular edges, and four increasing rounded corners, not only optimize the stress distribution of rail tubes, but also reduce local stress concentration, thereby improving the overall bearing capacity and adapting to the needs of more complex working conditions.

The large circular arc edge, small circular arc edge, and rounded corner are designed for each rail tube according to an increasing law, making the fitting clearance more precise. The reduced clearance effectively reduces the possible looseness and shaking during use, improving the accuracy and comfort of ladder use.

The circular arc edge and rounded corner designed for the cross section of rail tubes not only help to resist torsion, but also improve the smooth sliding between the rail tubes. Users can enjoy a smoother operating experience when stretching or retracting the ladder, while reducing lag or obstruction.

The unique design of bread shaped tubes, combined with streamlined circular arc edges and corners, not only makes the ladder more pleasing to the eye, but also increases the product's sense of technology and professionalism. This design better meets the aesthetic needs of users and further enhances the market appeal of the product.

Based on the optimized structural design, the rail tubes having a bread shaped cross section can better resist deformation or damage that may occur during use and extend the product's lifespan. Moreover, because of the improved anti-torsion ability and higher durability, the ladder also has the maintenance cost effectively reduced.

The unique design of bread shaped cross section, significantly different from the common circular tube structure in the market, makes the ladder not only perform well in terms of torsion resistance and load-bearing performance, but also adapt to more complex environments and professional application scenarios, further enhancing the product's market competitiveness and user experience.

In further, the fitting bumps are provided at positions on an inner wall of a plug-in channel of the bracket facing the first arc angle, the second arc angle, the first arc edge plate, and the second arc edge plate.

The fitting bumps are provided at positions on an inner wall of a plug-in channel of the bracket facing the first arc angle, the second arc angle, the first arc edge plate, and the second arc edge plate, making the fit between the bracket and the rail tube tighter. The designed multi-point fitting effectively disperses the torsional moment, and further enhances the anti-torsion ability of rail tubes during use, ensuring that the ladder is more stable and reliable.

The reasonable distribution of fitting bumps in the key stress areas of the rail tubes can evenly distribute the pressure between the rail tubes and the brackets, avoid wear or deformation caused by excessive local stress, thereby extending the service life of the ladder and reducing daily maintenance costs.

Adding fitting bumps at the first arc angle, second arc angle, and arc edge plate effectively reduces the fitting gap between the bracket and the rail tube, protecting the ladder against shaking or offset.

The designed multi-point fitting bumps make the rail tube more stable when subjected to lateral or torsional forces, reducing deformation or loosening caused by external forces. This design significantly improves the ladder's safety performance, especially in applications with high load or high-frequency use.

The bumps are distributed at specific positions of the first arc angle, the second arc angle, and the edge plate, reflecting the refined and scientific design of the ladder. This meticulous fitting design enhances the technical content of the product, making the ladder more competitive in the market.

The bracket, along with improved fitting bumps, enables the ladder to adapt to more complex working environments, including high-intensity construction scenarios or workplaces where frequent stretching and folding are required, providing users with a more stable and reliable user experience.

Compared to traditional bracket designs, this innovative design not only enhances the torsional resistance, but also optimizes the overall structural stability and safety, making the product stand out among similar products and further enhancing market competitiveness and user recognition.

In further, seven fitting bumps are configured.

Seven fitting bumps on the bracket significantly improve the contact area and strength between the bracket and the rail tube. The seven fitting bumps distributed in the new design evenly cover key areas, effectively limiting the relative rotation angle of the rail tube, greatly improving the anti-torsion performance of the ladder, so that the bracket is more securely installed with less fitting gap, and the ladder having higher stability and reliability under complex working conditions is suitable for various high-intensity work scenarios.

The fitting bumps of the bracket are designed with a reasonable distribution, and the force is evenly transmitted through seven fitting points to avoid assembly deformation caused by uneven force, further improving the overall quality and durability of the product.

The newly added fitting bumps are distributed in the key stress areas of the bracket, so that the force is more uniform, reducing the wear rate between the rail tube and the bracket, extending the service life of the ladder, and reducing the maintenance cost for users.

Based on the added fitting bumps, the bracket provides more stable support for the rail tube, and can effectively reduce the risk of shaking caused by excessive clearance, and further improve the overall safety performance of the ladder especially when the ladder is fully unfolded.

The seven-point design significantly improves the technical content of the ladder, not only enhancing its anti torsion ability, but also optimizing its stability and service life, making it more competitive among similar products and meeting the needs of users for high-performance ladders.

In further, the connector of each bracket is internally provided with a receiving cavity, each bracket is provided with a protruding portion facing the upper rung of rail, and each rail tube and ladder foot tube are provided with sockets;

the folding mechanism includes an automatic folding mechanism and a manual folding mechanism, the second to last rung of the ladder foot section is provided with the manual folding mechanism, and the remaining rails are provided with the automatic folding mechanism;

the manual folding mechanism comprises a second locking pin, a second spring, and a button, wherein the second locking pin is disposed in the receiving cavity of the bracket of the second to last rung of rail, and the second spring is sleeved on the second locking pin, one end of the second spring is pressed against the second locking pin, the other end of the second spring is pressed against an inner wall of the receiving cavity, the second spring forms a reset mechanism of the second locking pin, and the button is connected to the second locking pin;

the elastic force of the second spring pushes the second locking pin through the bracket and sequentially into the ladder foot tube and sockets of the last rung of rail tube, thereby locking the telescopic state of the last rung of rail tube and ladder foot tube;

the automatic folding mechanism comprises a first locking pin, a first spring, and a lever, wherein the first locking pin is disposed in the receiving cavity of the bracket of other rails, the first spring is sleeved on the first locking pin, one end of the first spring is pressed against the first locking pin, and the other end of the first spring is pressed against the inner wall of the receiving cavity, the first spring forms the reset mechanism of the first locking pin, one end of the lever is connected to the first locking pin, and the other end of the lever extends outside a rung to form a toggle portion;

the elastic force of the first spring pushes the first locking pin through the bracket and sequentially into the sockets of adjacent two rungs of rail tubes, thereby locking the telescopic state of adjacent two rungs of rail tubes;

press the button to overcome the elastic force of the second spring and drive the second locking pin to move, and the second locking pin moves away from the socket of the last rung of rail tube and ladder foot tube, so that the last rung of rail tube and ladder foot tube are in a free state;

the last rung of rail tube, under the action of gravity, slides into an inner cavity of the ladder foot tube;

under the action of gravity, the toggle portion of the upper rung of rail of the telescopic ladder section touches the protruding portion of the lower rung of rail, and meanwhile the toggle portion overcomes the elastic force of the first spring to drive the lever to move, and the lever drives the first locking pin to move away from the sockets of adjacent two rail tubes, so that the adjacent two rail tubes are in a free state;

the upper rung of rail tube slides into the inner cavity of the lower rung of rail tube under the action of gravity, and so on, and the rails of the telescopic ladder section are stacked, and an anti-pinching gap greater than a thickness of the palm is formed between the rung of the upper rail and the rung of the lower rail.

Users only need to press the button to activate the manual folding mechanism, the ladder can be automatically folded without cumbersome operation, so that the usage steps are simplified, and the user experience and operational convenience are greatly improved.

The telescopic ladder section implements step-by-step stacking of ladder rails through an automatic folding mechanism, and the rail tube are automatically pushed under the gravity into the lower rung of rail tube, saving the trouble of manual adjustment and significantly improving the folding efficiency.

During the folding process, the toggle portion of the upper rung of rail touches the protruding portion of the lower rung of rail, automatically forming an anti-pinching gap larger than the thickness of the palm, so that hand injuries are effectively avoided for users and the ladder's safety performance is improved.

Two types of folding mechanisms, manual and automatic, have been designed. The last rail of the telescopic ladder section is stacked through the manual folding mechanism of the ladder foot section, ensuring that users can accurately control the initial startup; The remaining rails are automatically stacked through an automatic folding mechanism, which combines the advantages of precision and efficiency.

Both the first and second locking pins are provided with independent spring return mechanisms, ensuring that the locking pins can quickly return to lock the rail tube to ensure the stability and safety of the ladder when retracted or unfolded.

The ladder is folded under the full utilization of gravity, so that users are not required to manually push the rail tube, and face lower labor intensity. The ladder is more suitable for scenarios where frequent use or quick folding is required.

This design is suitable for various scenarios such as household application and engineering construction, especially for work environments where frequent folding and unfolding is required, meeting users'comprehensive needs for convenience, safety, and high efficiency.

Based on the manual and automatic folding mechanisms, anti-pinching gap design, and efficient operating procedures, this innovative design significantly improves the technical level of telescopic ladder and user experience.

In further, a handle is provided at the bottom of the second to last rung of the ladder foot section, the buttons are provided on both sides of the handle, and the rung of the first rail and the second to last rung of the ladder foot section are both provided with binding straps.

The buttons have an increased contact area, making them easier to press compared to traditional designs, reducing the pressure on the hand during pressing, so that users can operate easily and effortless, and enjoy improved user experience.

The handle additionally added at the bottom of the second to last rung of the ladder foot section not only protects the buttons from external damage, but also facilitates users to grip during transportation, enhancing the ladder's portability and practicality.

The rung of the first rail and the second to last rung of the ladder foot section are provided with binding straps, so that users can use these straps to secure the folded ladder to avoid looseness and improve cleanliness and safety.

The handle designed provides a convenient grip point, making it easier for users to handle the ladder and reducing the risk of ladder slipping due to lack of grip points. It is particularly suitable for scenarios where frequent movement and use is required.

The integrated design of buttons and handles, as well as binding straps, make the use, folding, and storage of the ladder efficient and convenient, greatly optimizing the user experience.

The addition of handles and straps provides good protection during use and storage, avoiding damage to buttons or ladder rails due to impact or friction, and extending the service life of the ladder.

Based on an increased button area, a handle designed to protect the buttons, and convenient binding straps, this design further enhances the products'functionality and user experience, making it more attractive in the fiercely competitive ladder market.

The handles and binding straps enable the ladder to provide more convenient operation and safe folding in various scenarios such as outdoor operation, household storage, and transportation, significantly improving its adaptability.

### The Present Invention has the Following Beneficial Effects

In the present invention, the ladder rail is design with a “bread” shaped cross section, and forms a stable structure through the combination of the first arc edge plate, straight edge plate, and second arc edge plate. Compared with traditional circular tubes, this structure significantly improves the anti-torsion ability of rail tubes, and ensures the stability and durability of the ladder, especially performing better under high load operating conditions.

In the present invention, the arc-shaped surface of the rung increases the contact comfort of feet and reduces fatigue during long-term use. Meanwhile, the size of rungs increases step by step with the increasing size of ladder rail. Rungs of different sizes are configured for different ladder rails to improve the load-bearing capacity and ensure safety at different working heights.

In the present invention, the resilient and wear-resistant blocking plates on a side wall of rail tube form the blocking blocks, effectively preventing the rail tube from slipping out during the stretching process. When the blocking plates touch the inward flanging of the bracket of lower rail, the rail tube automatically stops stretching to provide reliable anti-detachment and greatly improve the safety performance of the ladder, especially in high-frequency applications.

In the present invention, fitting bumps are provided at positions on an inner wall of a plug-in channel of the bracket facing the first arc angle, the second arc angle, the first arc edge plate, and the second arc edge plate, making the fit between the bracket and the rail tube tighter. The designed multi-point fitting effectively disperses the torsional moment, and further enhances the anti-torsion ability of rail tubes during use, ensuring that the ladder is more stable and reliable.

During the folding process, the toggle portion of the upper rung of rail touches the protruding portion of the lower rung of rail, automatically forming an anti-pinching gap larger than the thickness of the palm, so that hand injuries are effectively avoided for users and the ladder's safety performance is improved.

In the present invention, users only need to press a button to activate the manual folding mechanism, and the telescopic ladder section implements step-by-step stacking of ladder rails through an automatic folding mechanism, and the rail tube are automatically pushed under the gravity into the lower rung of rail tube, saving the trouble of manual adjustment and significantly improving the folding efficiency; the ladder can be automatically folded without cumbersome operation, so that the usage steps are simplified, and the user experience and operational convenience are greatly improved.

In the present invention, the upper rung of “bread shaped” rail tube is inserted into the lower rung of “bread shaped” rail tube through the plug-in channel of the bracket, and seven fitting bumps provide multi-point support and constraint on the rail tube. The distribution of bumps fit with the shape of rail tubes, providing comprehensive anti-torsion constraints.

### BRIEF DESCRIPTION OF DRAWINGS

FIG. 1 is a schematic diagram of the telescopic ladder (in folded state).

FIG. 2 is a schematic diagram of the telescopic ladder (in folded state) from another angle.

FIG. 3 is the front view of the telescopic ladder (in folded state).

FIG. 4 is an enlarged view of part A of FIG. 3.

FIG. 5 is an enlarged view of part B of FIG. 3.

FIG. 6 is a cross-sectional view of FIG. 3.

FIG. 7 is a schematic diagram of the telescopic ladder (in unfolded state).

FIG. 8 is a schematic diagram of the telescopic ladder (in unfolded state) from another angle.

FIG. 9 is the front view of the telescopic ladder (in unfolded state).

FIG. 10 is a sectional view of the telescopic ladder.

FIG. 11 is an enlarged view of part C of FIG. 10.

FIG. 12 is an enlarged view of part D of FIG. 10.

FIG. 13 is a schematic diagram of the rail.

FIG. 14 is an assembly diagram of the rail.

FIG. 15 is a schematic cross-sectional view of the rail tube.

FIG. 16 is a schematic cross-sectional view of the rung.

FIG. 17 is a schematic diagram of the bracket.

FIG. 18 is a schematic diagram of the bracket from another angle.

FIG. 19 is a schematic diagram of the bracket.

FIG. 20 is a schematic diagram of the bracket from another angle.

FIG. 21 is a schematic diagram of the bracket from another angle.

### DESCRIPTION OF EMBODIMENTS

The present invention will be further described in conjunction with the accompanying drawings and embodiments:

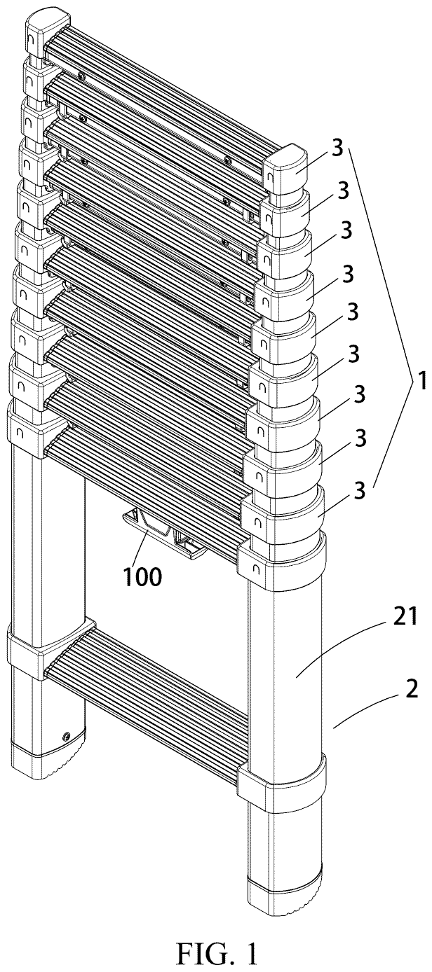

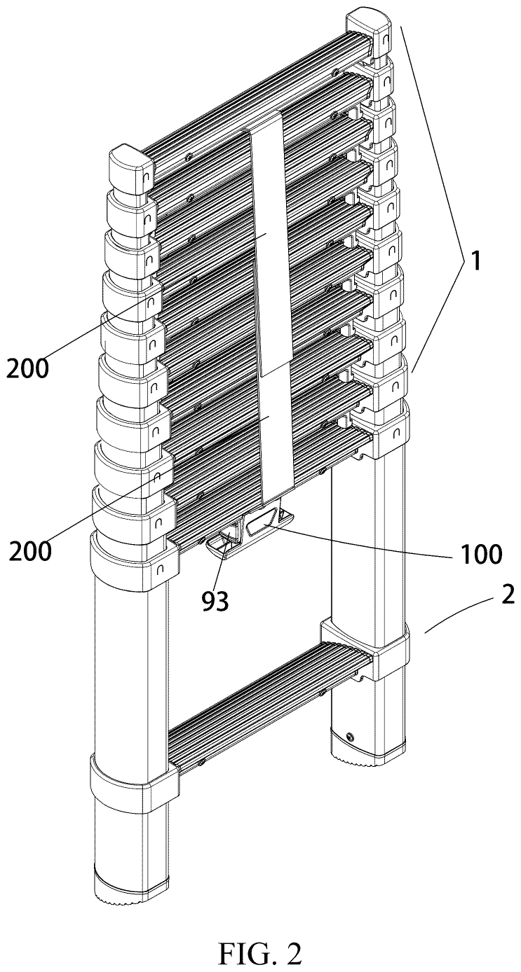

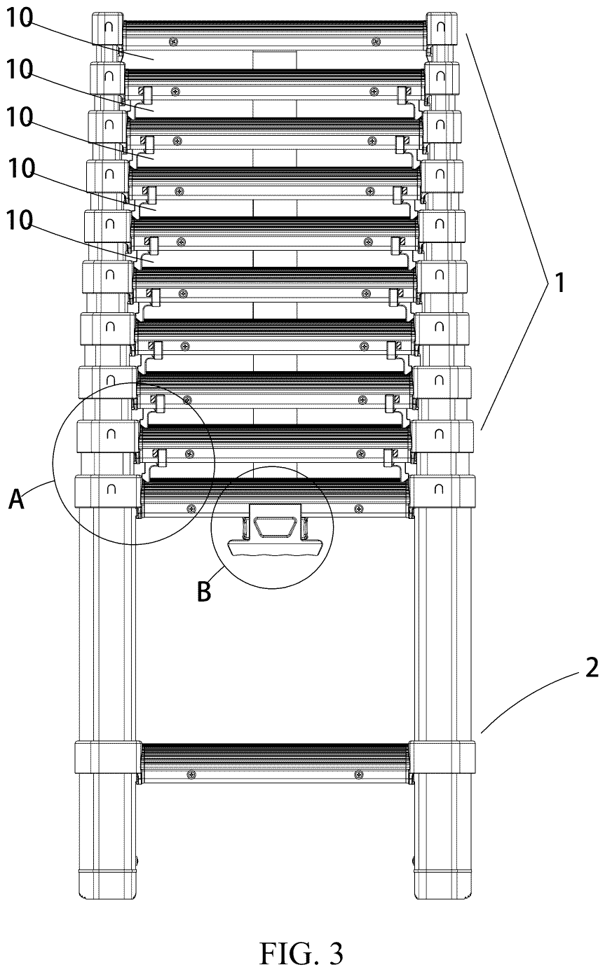

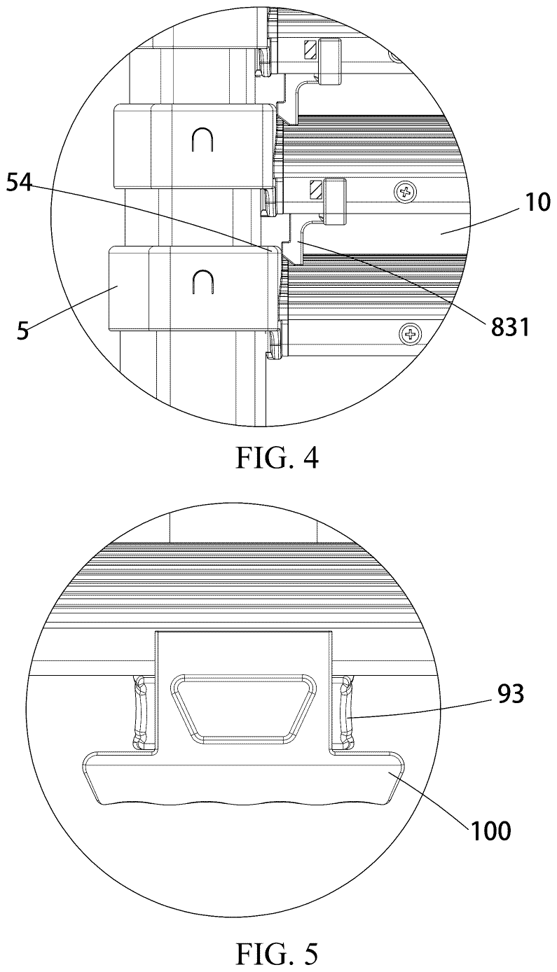

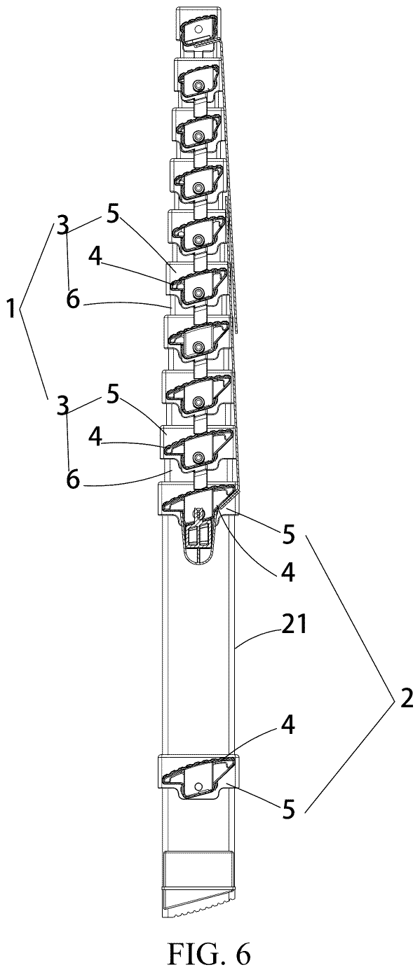

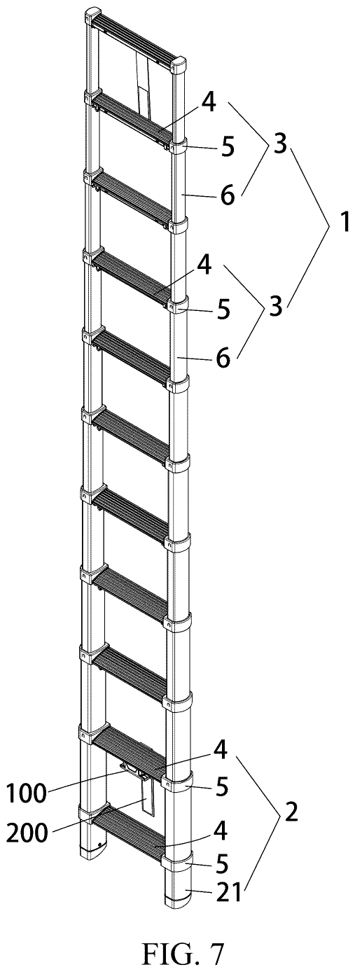

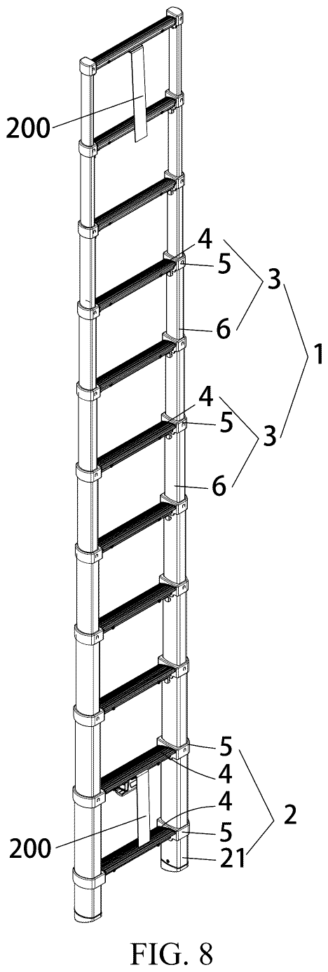

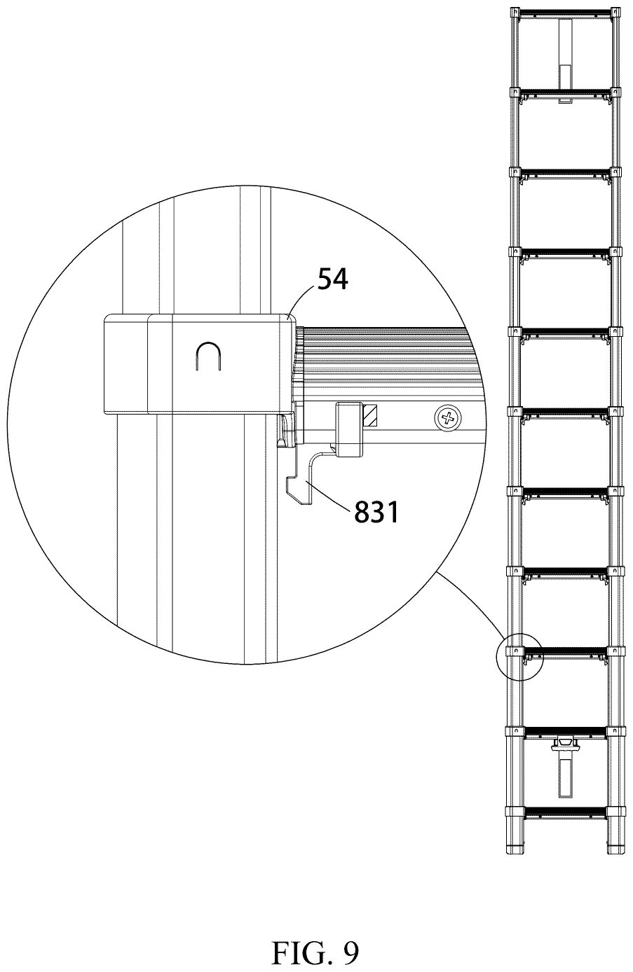

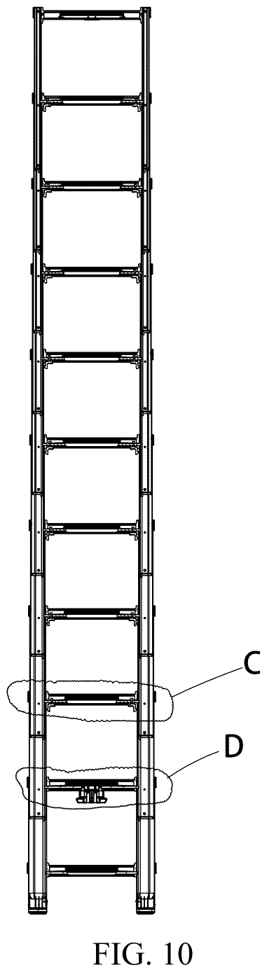

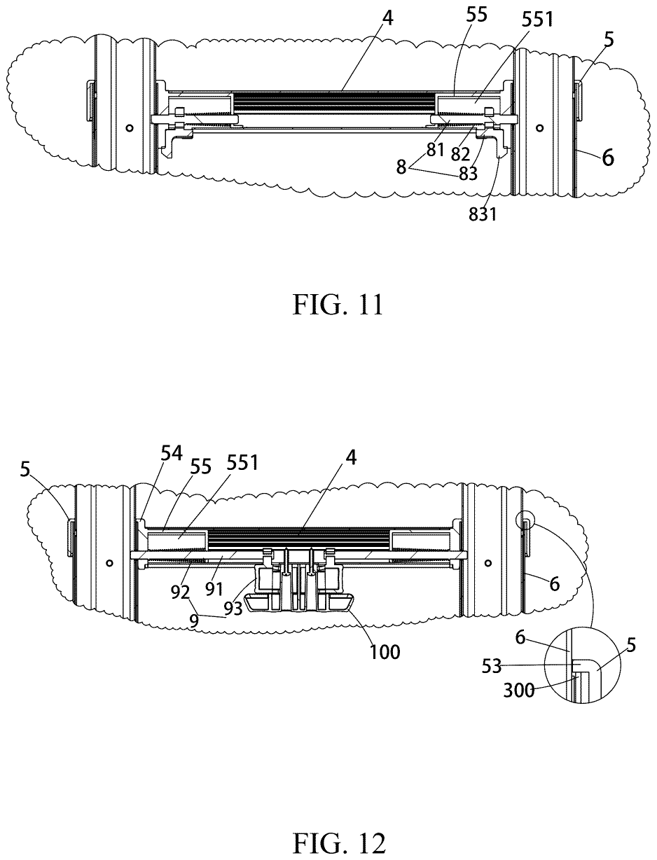

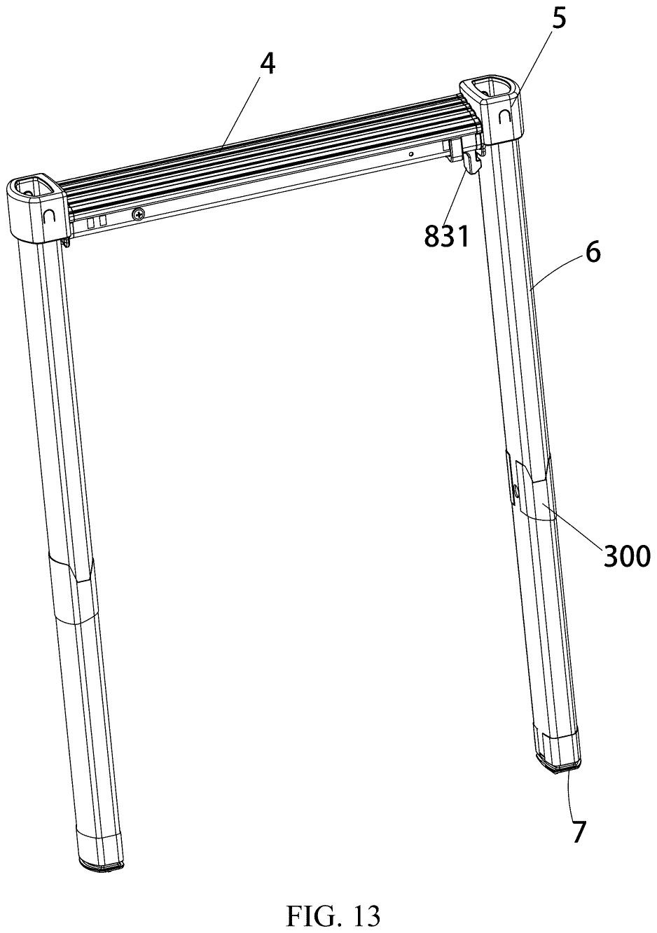

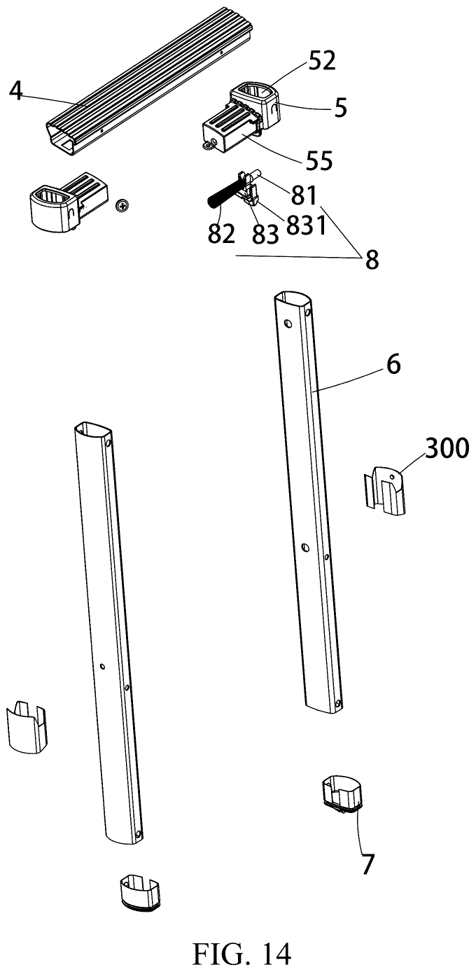

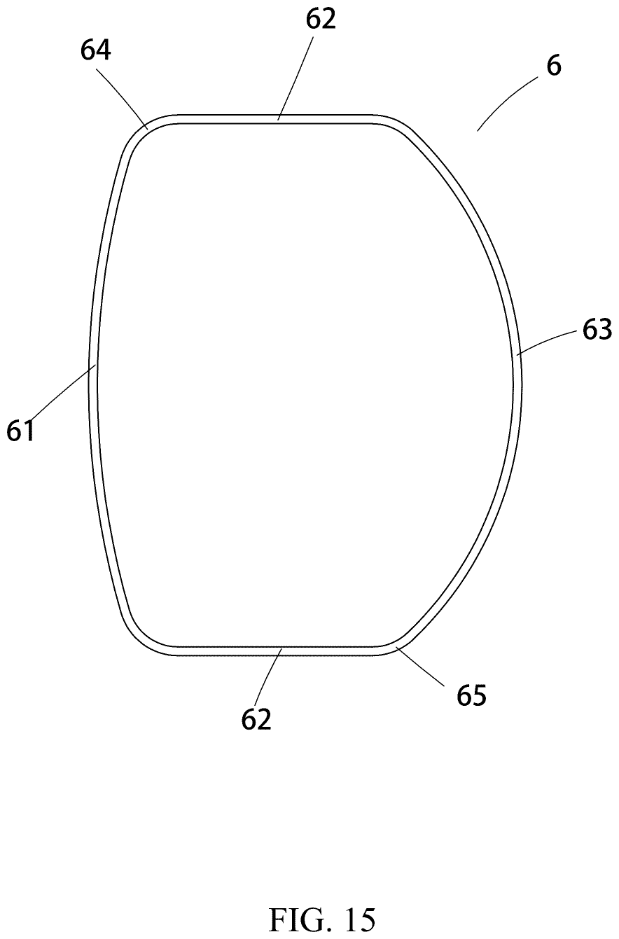

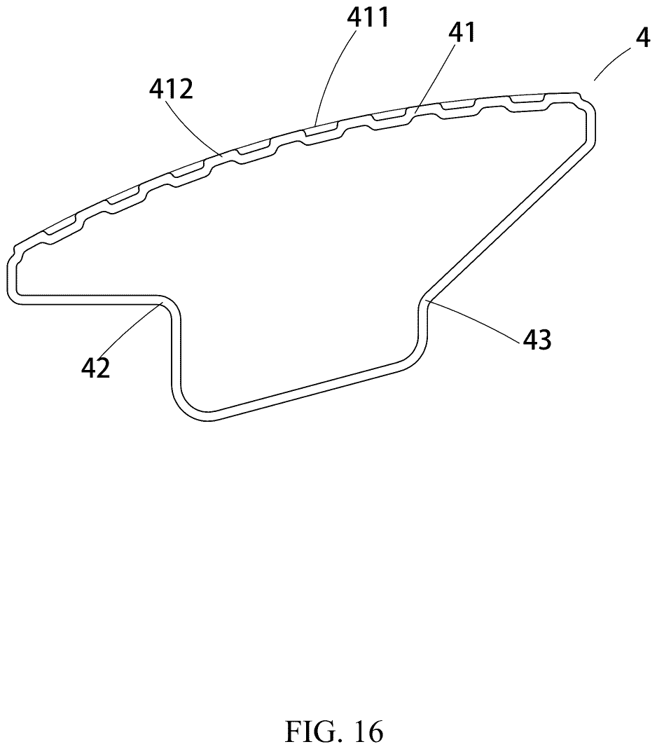

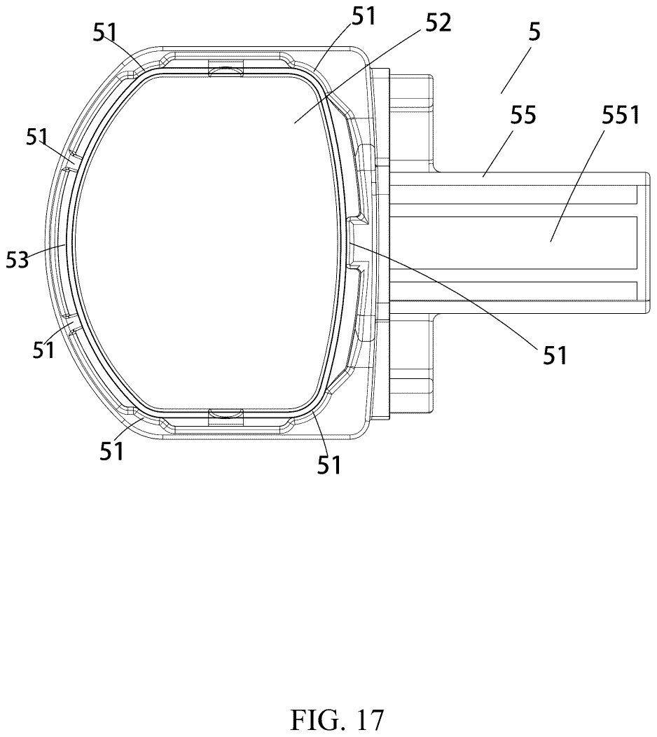

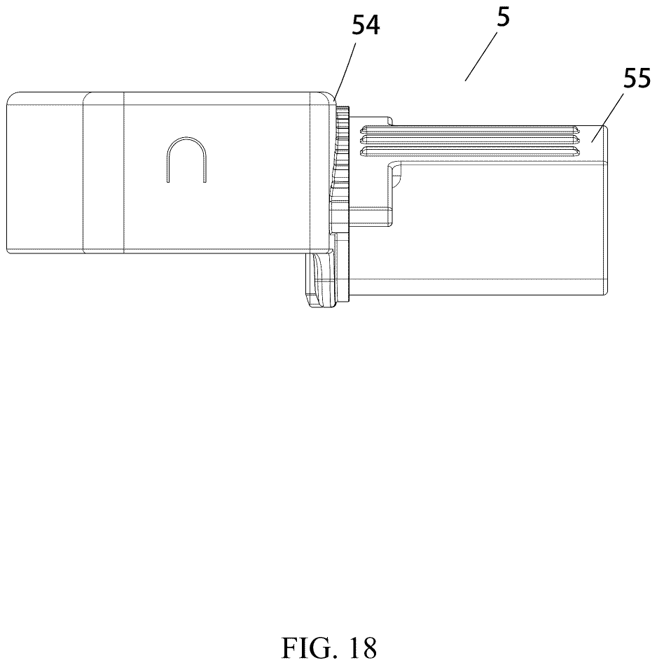

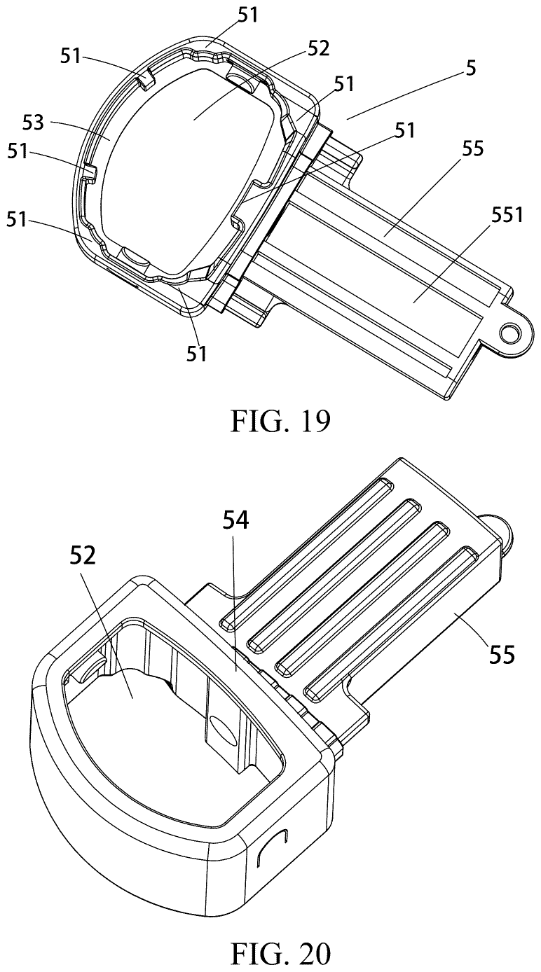

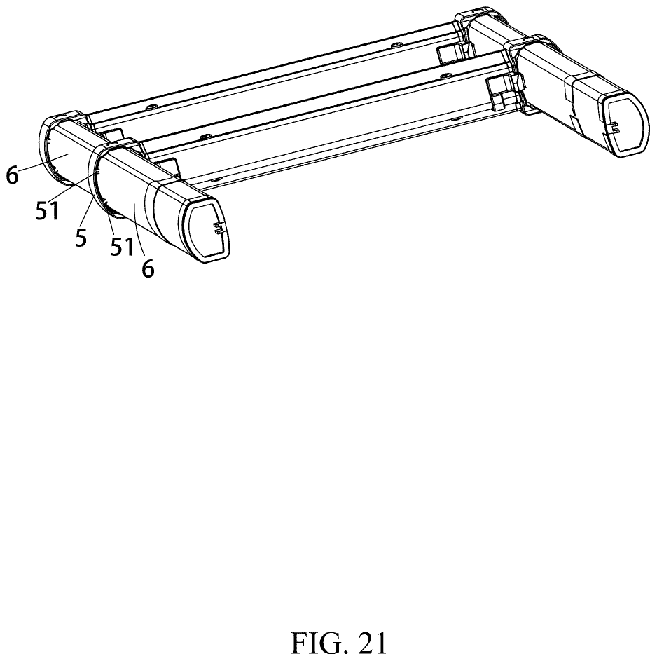

Based on the embodiments shown in FIG. 1 to 21, a telescopic ladder comprises a telescopic ladder section 1 and a ladder foot section 2, wherein the telescopic ladder section 1 comprises a rail 3 that is configured to have a fit between at least two rungs, each rung of rail 3 includes a rung 4, a bracket 5, and a rail tube 6;

the bracket 5 has a plug-in channel 52 that runs through the top and bottom, a connector 55 is provided on the side of the bracket 5, the inner wall of the plug-in channel 52 is spaced with at least four fitting bumps 51, and a upper port of the plug-in channel 52 is provided with an inward flanging 53 that extends towards the center direction of the plug-in channel 52;

the upper end of each rail tube 6 is inserted into the corresponding bracket's 5 plug-in channel 52 through the lower port of plug-in channel 52 and pressed against the inward flanging 53 to connect the rail tube 6 and the bracket 5, the fitting bumps 51 reduce the fitting gap between the rail tube 6 and the plug-in channel 52 of bracket 5, and a descent control device is provided at a lower port of each rail tube 6;

the rungs 4 are disposed between the rail tubes 6, and the ends of the rungs 4 are connected to the corresponding connectors 55, respectively;

a rail tube 6 of an upper rung of rail 3 is disposed inside a rail tube 6 of a lower rung of the rail 3, and a folding mechanism is provided between the upper rung of rail 3 and lower rung of rail 3 to lock or unlock the unfolded state between the upper rung of rail 3 and the lower rung of rail 3;

the ladder foot section 2 comprises a rung 4, a bracket 5, and a ladder foot tube 21, wherein the bracket 5 is provided at the ladder foot tube 21, and a side of the bracket 5 is provided with a connector 55, the rung 4 is disposed between the ladder foot tubes 21, the ends of the rung 4 are connected to the corresponding connectors 55, respectively;

the rail tube 6 of the last rung of rail 3 is sleeved inside the ladder foot tube 21 of the ladder foot section 2;

the rail tube 6 of the upper rung of rail 3 has a smaller size than the rail tube 6 of the lower rung of rail 3, and the rail tube 6 of the last rung of rail 3 has a smaller size than the ladder foot tube 21;

the rail tube 6 comprises a first arc edge plate 61, a straight edge plate 62, and a second arc edge plate 63, wherein one end of the straight edge plate 62 is connected to the first arc edge plate 61, and the other end of the straight edge plate 61 is connected to the second arc edge plate 63, a first circular arc angle 64 is formed at the connection between the straight edge plate 62 and the first arc edge plate 61, and a second circular arc angle 65 is formed at the connection between the straight edge plate 62 and the second arc edge plate 63, thereby enclosing a rail tube 6 having a “bread” shaped cross section;

an inner wall of an opening of the bracket 5 is spaced with at least four fitting bumps 51 that are configured to enclose a limit port 52, the upper rung of rail tube 6 passing through the limit port 52 of the bracket 5 is sleeved inside the rail tube 6 of the lower rung of rail 3, and the limit port 52 is configured to reduce a fitting gap between the upper rung of rail tube 6 and the bracket 5;

the rung 4 has a curved surface 411 that is easy to step on, and the size of the rung 4 of the telescopic ladder 1 is configured to increase with the size of the rail tube 6.

In further, the rung 4 comprises a circular arc plate 41, a right angle plate 42, and a bevel edge plate 43, and one end of the circular arc plate 41 is connected to the right angle plate 42, and the other end of the circular arc plate 41 is connected to the bevel edge plate 43, thereby enclosing a rung 4 having a “T” shaped cross section, the circular arc plate 41 has a circular arc surface 411, and the circular arc surface 411 is provided with a plurality of concave-convex anti-skid bars 412 at intervals.

In further, the descent control device comprises a bottom cover 7, and the bottom cover 7 is disposed at a lower port of the rail tube 6 and has an air hole.

In further, an inner wall of a plug-in channel 52 of bracket 5 is provided with an inward flanging 53 that extends toward the center of the plug-in channel 52, the rail tube 6 is provided with a blocking block, the rail tube 6 of the upper rung of rail 3 is configured to slide along an inner cavity of the rail tube 6 of the next rung of rail 6 until the blocking block is pressed against the inward flanging 53, and the upper rung of rail tube 6 and the lower rung of rail tube 6 are in a fully unfolded state.

In further, the telescopic ladder further comprises a resilient and wear-resistant blocking plate 300, wherein the blocking plate 300 is configured to be on a side wall of the rail tube 6 and forms the blocking block.

In further, a center of the first arc edge plate 61 and a center of the second arc edge plate 63 are on a same straight line, the first arc edge plate 61 has a greater radius than the second arc edge plate 63, and the first circular arc angle 64 has a same radius as the second circular arc angle 65.

In further, the fitting bumps 51 are provided at positions on an inner wall of an opening of the bracket 5 facing the first arc angle 64, the second arc angle 65, the first arc edge plate 61, and the second arc edge plate 51.

In further, seven fitting bumps 51 are configured.

In further, the connector 55 of each bracket 5 is internally provided with a receiving cavity 551, each bracket 5 is provided with a protruding portion 54 facing the upper rung of rail 3, and each rail tube 6 and ladder foot tube 21 are provided with sockets;

the folding mechanism includes an automatic folding mechanism 8 and a manual folding mechanism 9, the second to last rung 4 of the ladder foot section 2 is provided with the manual folding mechanism 9, and the remaining rails 3 are provided with the automatic folding mechanism 8;

the manual folding mechanism 9 comprises a second locking pin 91, a second spring 92, and a button 93, wherein the second locking pin 91 is disposed in the receiving cavity 551 of the second to last bracket 5 of the ladder foot section 2, and the second spring 92 is sleeved on the second locking pin 91, one end of the second spring 92 is pressed against the second locking pin 91, the other end of the second spring 92 is pressed against an inner wall of the receiving cavity 551, the second spring 92 forms a reset mechanism of the second locking pin 92, and the button 93 is connected to the second locking pin 91;

the elastic force of the second spring 92 pushes the second locking pin 91 through the bracket 5 and sequentially into the sockets of ladder foot tube 21 and the last rung of rail tube 6, thereby locking the telescopic state of the last rung of rail tube 6 and ladder foot tube 21;

the automatic folding mechanism 8 comprises a first locking pin 81, a first spring 82, and a lever 83, wherein the first locking pin 81 is disposed in the receiving cavity 551 of the bracket 5 of other rails 3, the first spring 82 is sleeved on the first locking pin 81, one end of the first spring 82 is pressed against the first locking pin 81, and the other end of the first spring 82 is pressed against the inner wall of the receiving cavity 551, the first spring 82 forms the reset mechanism of the first locking pin 81, one end of the lever 83 is connected to the first locking pin 81, and the other end of the lever 83 extends outside a rung 4 to form a toggle portion 831;

the elastic force of the first spring 82 pushes the first locking pin 81 through the bracket 5 and sequentially into the sockets of adjacent two rungs of rail tubes 6, thereby locking the telescopic state of adjacent two rungs of rail tubes 6;

press the button 93 to overcome the elastic force of the second spring 92 and drive the second locking pin 91 to move, and the second locking pin 91 moves away from the socket of the last rung of rail tube 6 and ladder foot tube 21, so that the last rung of rail tube 6 and ladder foot tube 21 are in a free state;

the last rung of rail tube 6, under the action of gravity, slides into an inner cavity of the ladder foot tube 21;

under the action of gravity, the toggle portion 831 of the upper rung of rail 3 of the telescopic ladder section 1 touches the protruding portion 54 of the lower rung of rail 3, an anti-pinching gap 10 greater than a thickness of the palm is formed between the rung 4 of the upper rail 3 and the rung 4 of the lower rail 3, and meanwhile the toggle portion 831 overcomes the elastic force of the first spring 82 to drive the lever 83 to move, and the lever 83 drives the first locking pin 81 to move away from the sockets of adjacent two rail tubes 6, so that the adjacent two rail tubes 6 are in a free state;

the upper rung of rail tube 6 slides into the inner cavity of the lower rung of rail tube 6 under the action of gravity, and so on, and the rails 3 of the telescopic ladder section 1 are stacked, and an anti-pinching gap 10 greater than a thickness of the palm is formed between the rung 4 of the upper rail 3 and the rung 4 of the lower rail 3.

In further, a handle 100 is provided at the bottom of the second to last rung 4 of the ladder foot section 2, the buttons 93 are provided on both sides of the handle 100, and the rung 4 of the first rail 3 and the second to last rung 4 of the ladder foot section 2 are both provided with binding straps 200.

The “bread shaped” rail tube 6 has the following significant advantages:

The “bread shaped” design makes the rail tube 6 rounded without sharp edges, more pleasing to the eye, and also reduces potential harm to users during use, improving safety and user experience.

The “bread shaped” cross section of rail tube 6 is composed of a first arc edge plate 61, a second arc edge plate 63, and a straight edge plate 62, with a symmetrical overall shape and compact structure. The curvature distribution of arc edge plate increases the torsional rigidity of the pipe, effectively dispersing torque and avoiding pipe deformation.

The straight edge plate 62 connects the arc edge plates on both sides, forming a sturdy support structure that enhances the bending strength of the rail tube 6 and can withstand higher loads.

The arc surface designed for the first arc edge plate 61 and the second arc edge plate 63 increases the contact area between the bracket 5 and the rail tube 6, improves the fitting stability, and reduces the shaking and displacement caused by gaps.

The combination of arc surface and straight edge enables the rail tube 6 to resist both torsional and bending forces, avoiding instability caused by a single force mode during use.

### Distribution Characteristics of Fitting Bump 51

Seven fitting bumps 51 are provided on the inner wall of the plug-in channel 52 of bracket 5 at the key stress points of rail tube 6 (first arc angle 64, second arc angle 65, first arc edge plate 61, and second arc edge plate 63 positions). These fitting bumps are evenly distributed to enclose the limit port 52 to precisely fit the “bread shaped” cross-sectional structure of rail tube 6.

### Fitting Relationship Between Rail Tube 6 and Bracket 5

The rail tube 6 is inserted into the plug-in channel 52 of the bracket 5 to connect the ladder rail 6 and the bracket 5, and seven fitting bumps 51 provide multi-point support and constraint on the rail tube 6, and the distribution of fitting bumps 51 fit with the shape of rail tubes 6, providing comprehensive anti-torsion constraints.

### Reasons for Enhanced Anti-Torsion Ability

Seven fitting bumps 51 provide more contact points to more effectively limit the rotational freedom of the rail tube 6 compared to traditional designs.

Seven fitting bumps 51 cover the key parts of the arc angle and edge plate, so that the torque is dispersed to multiple support points, and deformation or loosening caused by concentrated stress is avoided.

The close fit between the limit port 52 enclosed by the bumps and the rail tube 6 reduces the assembly clearance and further enhances the stability and anti-torsion performance of the structure.

The combination of the seven fitting bumps 51 of bracket 5 and the “bread shaped” rail tube 6 fully utilizes the advantages of multi-point support and shape fit, significantly improving the anti-torsion ability of rail 3 and ensuring its stability and safety in use.

### Structural Characteristics of the Rung 4

Different rail tubes 6 are provided with corresponding sized rungs 4, and the width of rungs 4 increases step by step with the size of rail tubes 6, enhancing the load-bearing capacity of rungs 4. This design is more in line with the demand for load-bearing performance when the ladder has an increasing height, making ladder climbing-up and-down safer and more stable, suitable for various work scenarios.

The circular arc tread surface not only conforms to the sole structure, but also reduces the pressure on the foot during long-term operation, significantly improving users'comfort. This design is particularly suitable for working at height that require prolonged standing or climbing.

The arrangement of concave-convex anti-skid bars 412 at intervals on the circular arc plate 41 effectively improves users'operation safety in various complex environments, and significantly reduces the risk of slipping, especially in rainy or oily fields.

### Benefits of Handle 100

The handle 100 not only protects the buttons 93 from external damage, but also facilitates users to grip during transportation, enhancing the ladder's portability and practicality.

### Benefits of Increasing the Contact Area of Button 93

The buttons 93 have an increased contact area, making them easier to press compared to traditional designs, reducing the pressure on the hand during pressing, so that users can operate easily and effortless, and enjoy improved user experience.

### Benefits of Binding Straps 200

The rung 4 of the first rail 3 and the second to last rung 4 of the ladder foot section 2 are provided with binding straps 200, so that users can use these straps 200 to secure the folded ladder to avoid looseness and improve cleanliness and safety.

### Benefits of Blocking Plate 300

The resilient and wear-resistant blocking plates 300 on a side wall of rail tube 6 form the blocking blocks, and when the blocking plates 300 touch the inward flanging 53 of the bracket 5 of lower rail 3, the rail tube 6 automatically stops stretching to provide reliable anti-detachment and greatly improve the safety performance of the ladder, especially in high-frequency applications.

The use of wear-resistant blocking plates 300 as an anti-detachment structure not only extends the service life of the rail tube 6, but also reduces the risk of wear, thereby reducing subsequent maintenance costs and improving the durability of the ladder.

The blocking plates 300 can eliminate some gaps between the upper and lower rungs of rail tubes 6, reducing shaking or noise caused by looseness. This optimized gap design improves the overall stability of the ladder, making it smoother and safer to use.

The blocking plates 300 play a stable guiding role when the rail tube 6 is stretching, and avoids the deviation or jamming of rail tubes 6, so that the ladder can stretch smoothly and more efficiently.

### Method to Unfold the Telescopic Ladder

### Check the Status of the Ladder

Place the ladder horizontally or stand against the wall, loosen the binding strap 200 that secures the ladder, ensure that the rail 3 and ladder foot section 2 are not damaged, and that the button 93 and locking pin are in normal working condition.

### Unfold the Rails 3 Step by Step

Starting from ladder foot section 2, pull the last rung of rail 3 upwards to slide rail tube 6 out of the inner cavity of ladder foot tube 21.

When the rail tube 6 moves upward to the limit position of the inward flanging 53 of the bracket 5, the blocking block is pressed against the inward flanging 53 to ensure that the rail 3 is fully unfolded.

Meanwhile, the second locking pin 91 is inserted into the sockets of the ladder foot tube 21 and the rail tube 6 under the elastic force of the second spring 92, locking the telescopic state.

### Unfold Other Rails 3 in Sequence

Lift the upper rung of rail tube 6 step by step and slide it out from the lower rung of rail tube 6.

When each rung of rail tube 6 moves to the limit position of bracket 5, the blocking block is pressed against the inward flanging 53, and the first locking pin 81 is automatically inserted into the sockets of adjacent two rungs of rail tubes 6 under the elastic force of the first spring 82, completing the locking.

### Check the Unfolding Stability

Confirm that each rung of rail 3 has been fully unfolded and locked, check if the rungs 4 are stable, and ensure the safety of the ladder.

### Adjust the Operation Angle

Adjust the placement angle of ladder foot section 2 as needed to keep the ladder in a stable state and ensure safe use.

### Method to Fold the Telescopic Ladder

### Start the Manual Folding Mechanism 9

Press the buttons 93 on both sides of the handle 100 to overcome the elastic force of the second spring 92, so that the second locking pin 91 moves out of the socket of the last rung of rail tube 6 and ladder foot tube 21, and release the locked state.

Under the action of gravity, the last rung of rail tube 6 slowly slides into the inner cavity of the ladder foot tube 21.

### Trigger the Automatic Folding Mechanism 8

When the last rung of rail 3 slides into the inner cavity of the ladder foot tube 21, its toggle portion 831 touches the protruding portion 54 of the bracket 5 connecting to the second to last rung 4 of the ladder foot section 2.

The anti-pinching gap 10, which is greater than the thickness of the palm, is formed between the second to last rung 4 of the ladder foot section 2 and the rung 4 of the last rail 3 to ensure safety.

The toggle portion 831 overcomes the elastic force of the first spring 82, drives the lever 83 to move, so that the first locking pin 81 moves out of the socket of the adjacent two rail tubes 6, releasing the locking state.

### Fold the Rail 3 Step by Step

Under the action of gravity, the second to last rail tube 6 slowly slides into the inner cavity of the final rail tube 6.

Repeat the above process, slide the rail tube 6 step by step, and complete the stacking of all rails 3.

### Ensure the Anti-Pinching Safety

When the toggle portion 831 of each rung of rail 3 touches the protruding portion 54 of the lower rung of rail 3, a safety anti-pinching gap 10 is formed to avoid finger injury during operation.

### Complete Folding and Fixation

After all rail tubes 6 are fully folded, use a binding strap 200 to secure the rung 4 of the first rail 3 and the second to last rung 4 of the ladder foot section 2, ensuring that the ladder will not loosen during transportation or storage.

Check if the handle 100 and button 93 of the ladder are in normal condition.

What is claimed is:

1. A telescopic ladder comprising a telescopic ladder section and a ladder foot section, wherein the telescopic ladder section comprises a rail that is configured to have a fit between at least two rungs:
each rung of rail includes a rung, a bracket, and a rail tube, wherein the bracket has a plug-in channel that runs through the top and bottom, a connector is provided on the side of the bracket, the inner wall of the plug-in channel is spaced with at least four fitting bumps, and a upper port of the plug-in channel is provided with an inward flanging that extends towards the center direction of the plug-in channel;
the upper end of each rail tube is inserted into the corresponding bracket's plug-in channel through the lower port of plug-in channel and pressed against the inward flanging to connect the rail tube and the bracket, the fitting bumps reduce the fitting gap between the rail tube and the plug-in channel of bracket, and a descent control device is provided at a lower port of each rail tube;
the rungs are disposed between the rail tubes, and the ends of the rungs are connected to the corresponding connector, respectively;
a rail tube of an upper rung of rail is disposed inside a rail tube of a lower rung of the rail, and a folding mechanism is provided between the upper rung of rail and lower rung of rail to lock or unlock the unfolded state between the upper rung of rail and the lower rung of rail;
the ladder foot section comprises a rung, a bracket, and a ladder foot tube, wherein the bracket is provided at the ladder foot tube, and the rung is disposed between the rail tubes, the ends of the rung are connected to the corresponding connectors, respectively;
the rail tube of the last rail is sleeved inside the ladder foot tube of the ladder foot section;
the rail tube of the upper rung of rail has a smaller size than the rail tube of the lower rung of rail, and the rail tube of the last rail has a smaller size than the ladder foot tube;
the rail tube comprises a first arc edge plate, a straight edge plate, and a second arc edge plate, wherein one end of the straight edge plate is connected to the first arc edge plate, and the other end of the straight edge plate is connected to the second arc edge plate, a first circular arc angle is formed at the connection between the straight edge plate and the first arc edge plate, and a second circular arc angle is formed at the connection between the straight edge plate and the second arc edge plate, thereby enclosing a rail tube having a “bread” shaped cross section;
an inner wall of an opening of the bracket is spaced with at least four fitting bumps that are configured to enclose a limit port, the upper rung of rail tube passing through the limit port of the bracket is sleeved inside the rail tube of the lower rung of rail, and the limit port is configured to reduce a fitting gap between the upper rung of rail tube and the bracket;
the rung has a curved surface that is easy to step on, and the size of the rung of the telescopic ladder is configured to increase with the size of the rail tube.

2. The telescopic ladder according to claim 1, wherein the rung comprises a circular arc plate, a right angle plate, and a bevel edge plate, and one end of the circular arc plate is connected to the right angle plate, and the other end of the circular arc plate is connected to the bevel edge plate, thereby enclosing a rung having a “T” shaped cross section, the circular arc plate has a circular arc surface, and the circular arc surface is provided with a plurality of concave-convex anti-skid bars at intervals.

3. The telescopic ladder according to claim 1, wherein the descent control device comprises a bottom cover, and the bottom cover is disposed at a lower port of the rail tube and has an air hole.

4. The telescopic ladder according to claim 1, wherein the rail tube is provided with a blocking block, the rail tube of the upper rung of rail is configured to slide along an inner cavity of the rail tube of the next rung of rail until the blocking block is pressed against the inward flanging, and the upper rung of rail tube and the lower rung of rail tube are in a fully unfolded state.

5. The telescopic ladder according to claim 4, further comprising a resilient and wear-resistant blocking plate, wherein the blocking plate is configured to be on a side wall of the rail tube and forms the blocking block.

6. The telescopic ladder according to claim 1, wherein a center of the first arc edge plate and a center of the second arc edge plate are on a same straight line, the first arc edge plate has a greater radius than the second arc edge plate, and the first arc angle has the same radius as the second arc angle.

7. The telescopic ladder according to claim 1, wherein the fitting bumps are provided at positions on an inner wall of a plug-in channel of the bracket facing the first arc angle, the second arc angle, the first arc edge plate, and the second arc edge plate.

8. The telescopic ladder according to claim 7, wherein seven fitting bumps are configured.

9. The telescopic ladder according to claim 1, wherein the connector of each bracket is internally provided with a receiving cavity, each bracket is provided with a protruding portion facing the upper rung of rail, and each rail tube and ladder foot tube are provided with sockets;
the folding mechanism includes an automatic folding mechanism and a manual folding mechanism, the second to last rung of the ladder foot section is provided with the manual folding mechanism, and the remaining rails are provided with the automatic folding mechanism;
the manual folding mechanism comprises a second locking pin, a second spring, and a button, wherein the second locking pin is disposed in the receiving cavity of the bracket of the second to last rung of rail, and the second spring is sleeved on the second locking pin, one end of the second spring is pressed against the second locking pin, the other end of the second spring is pressed against an inner wall of the receiving cavity, the second spring forms a reset mechanism of the second locking pin, and the button is connected to the second locking pin;
the elastic force of the second spring pushes the second locking pin through the bracket and sequentially into the ladder foot tube and sockets of the last rung of rail tube, thereby locking the telescopic state of the last rung of rail tube and ladder foot tube;
the automatic folding mechanism comprises a first locking pin, a first spring, and a lever, wherein the first locking pin is disposed in the receiving cavity of the bracket of other rails, the first spring is sleeved on the first locking pin, one end of the first spring is pressed against the first locking pin, and the other end of the first spring is pressed against the inner wall of the receiving cavity, the first spring forms the reset mechanism of the first locking pin, one end of the lever is connected to the first locking pin, and the other end of the lever extends outside a rung to form a toggle portion;
the elastic force of the first spring pushes the first locking pin through the bracket and sequentially into the sockets of adjacent two rungs of rail tubes, thereby locking the telescopic state of adjacent two rungs of rail tubes;
press the button to overcome the elastic force of the second spring and drive the second locking pin to move, and the second locking pin moves away from the socket of the last rung of rail tube and ladder foot tube, so that the last rung of rail tube and ladder foot tube are in a free state;
the last rung of rail tube, under the action of gravity, slides into an inner cavity of the ladder foot tube;
under the action of gravity, the toggle portion of the upper rung of rail of the telescopic ladder section touches the protruding portion of the lower rung of rail, and meanwhile the toggle portion overcomes the elastic force of the first spring to drive the lever to move, and the lever drives the first locking pin to move away from the sockets of adjacent two rail tubes, so that the adjacent two rail tubes are in a free state;
the upper rung of rail tube slides into the inner cavity of the lower rung of rail tube under the action of gravity, and so on, and the rails of the telescopic ladder section are stacked, and an anti-pinching gap greater than a thickness of the palm is formed between the rung of the upper rail and the rung of the lower rail.

10. The telescopic ladder according to claim 9, wherein a handle is provided at the bottom of the second to last rung of the ladder foot section, the buttons are provided on both sides of the handle, and the rung of the first rail and the second to last rung of the ladder foot section are both provided with binding straps.
